(19) United States
(12) Patent Application Publication
(10) Pub. No.: US 2005/0015319 A1
(43) Pub. Date: Jan. 20, 2005

(54) Computer-implemented method for automatic contract monitoring

(76) Inventors: Kemal Guler, Cupertino, CA (US); Dirk Beyer, Walnut Creek, CA (US); Cipriano Santos, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/443,930

(22) Filed: May 21, 2003

(51) Int. Cl. G06F 17/60

(52) U.S. Cl. 705/35; 705/1

(57) ABSTRACT

A computer-implemented method for automatic contract monitoring. An electronic version of a contract comprising at least one term and at least one penalty is received. Information relevant to enforcement of contract is monitored. A transaction related to the contract is received. Using the information, it is automatically determined whether the transaction is compliant with the contract.

### FIELD OF INVENTION

Various embodiments of the present disclosure relate to the field of electronic exchanges.

### BACKGROUND OF THE INVENTION

Markets occupy a key place in the information flows necessary for the formation, monitoring and settlement of bilateral contracts between businesses. In particular, in the business-to-business spot marketplace a significant portion of trading activity has a close connection to bilateral contracts between two firms. Often, long-term contracts between two firms are written to contain provision that can be verified over time. For example, the contract may contain a provision in which the purchaser commits to a total purchase quantity over a year, wherein the shipments are flexible by the supplier. In another example, the purchaser commits to purchase a fixed percentage of total demand from a specific vendor. Typically, these clauses are protected by penalties.

It is usually very expensive to monitor compliance and to collect penalties. Compliance monitoring is usually performed manually by humans (e.g. accountants), as is the brokering of settlements (e.g., lawyers). As a result, contracted prices are unnecessarily expensive and penalties are typically high to account for the anticipated costs of researching and verifying a breach of contract. Nonetheless, in some instances it is beneficial for one party to deviate from the contract and incur the penalty, often resulting in costly litigation and damage to the business relationship

Currently, typical Internet-based trading and market platforms inherit the structure of offline markets and institutions that govern contractual relations. As an electronic embodiment of its off-line counterpart, an Internet-based marketplace is composed of electronic analogs of agents for market clearing specialists for each item that is traded. Similarly, Internet-based contract formation/monitoring/fulfillment systems exploit little more than the electronic data transfer capabilities that come with the new technology in that they are electronic embodiments of off-line conflict resolution, contract formation, contract settlement or contract monitoring/auditing services.

In the physical economy, a number of factors ranging from technological feasibility to pure evolutionary hysteresis determine the structure of markets and other institutions that come into play in managing various contingencies that arise during the lifetime of contractual relationships. The complex interplay of many such factors has produced a system in which the management of various phases and contingencies that arise during the course of a bilateral contractual relationship between two parties is highly compartmentalized. Public courts or specialized private arbitration systems are used to resolve litigation or settle conflicts that may arise during a contractual relationship, and markets for purchase/sale/matching/allocation of various goods/services/claims that come into existence during the same time period.

In particular, settlement of breaches of contracts that govern bilateral trading relationships and buying/selling of goods/services/claims is carried out through physically and logically separate institutional subsystems. This separation reflects the economic, legal, historical and technological factors and constraints that produced the specific institutional framework in the off-line economy. Specifically, the costs associated with monitoring and settling breaches of contracts are often substantial, limiting the applicability of employing contract remedies and other contract terms as a business tool.

### SUMMARY OF THE INVENTION

Various embodiments of the present invention, a computer-implemented method for automatic contract monitoring, are provided. An electronic version of a contract comprising at least one term and at least one penalty is received. Information relevant to enforcement of contract is monitored. A transaction related to the contract is received. Using the information, it is automatically determined whether the transaction is compliant with the contract.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates a block diagram of a market clearing system upon which embodiments of the present invention may be implemented.

FIG. 2 is a flowchart illustrating steps in computer-implemented process for automatic contract monitoring, in accordance with embodiments of the present invention.

FIG. 3 is a flowchart illustrating steps in computer-implemented process for validating a contract, in accordance with embodiments of the present invention.

FIG. 4 is a flowchart illustrating steps in computer-implemented process for determining whether a transaction is in compliance with a contract, in accordance with embodiments of the present invention

FIG. 5 illustrates a block diagram of a clearing agent in accordance with embodiments of the present invention.

### BEST MODE(S) FOR CARRYING OUT THE INVENTION

Reference will now be made in detail to various embodiments of the invention, examples of which are illustrated in the accompanying drawings. While the invention will be described in conjunction with various embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention.

Embodiments of the present invention provide a method and system thereof for monitoring contract compliance. In one embodiment, an infrastructure for an exchange (marketplace) containing automated contract compliance monitoring as well as automated determination of penalties if contracts are violated is described. By receiving contracts including terms that can be validated according to public and private information, contract monitoring can be automated, and penalties can be automatically assessed.

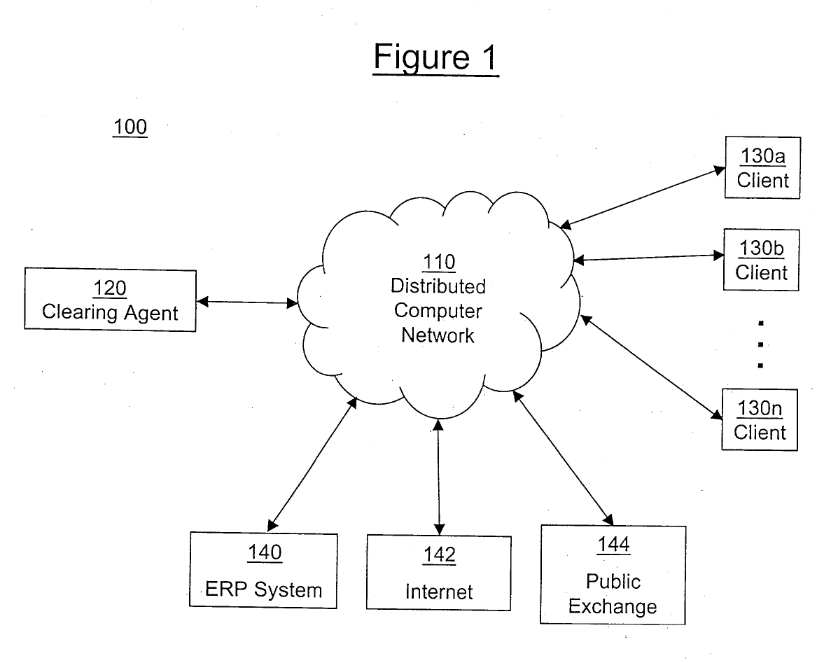

FIG. 1 illustrates a block diagram of a market-clearing system 100 upon which embodiments of the present invention may be implemented. As depicted in FIG. 1, market-clearing system 100 includes clearing agent 120 communicatively coupled to a plurality of clients 130a-n via a distributed computer network 110. It should be appreciated that market-clearing system 100 may comprise any number of clients, and that the present embodiment as depicted is exemplary. Furthermore, as depicted in FIG. 1, market-clearing system 100 comprises Enterprise Resource Planning (ERP) system 140, Internet 142, and public exchange 144. It should be appreciated that ERP system 140, Internet 142 and public exchange 144 are optional. Furthermore, it should be appreciated that other sources of information for determining breaches in the terms of a contract in addition to ERP system 140, Internet 142, and public exchange 144 may be included in system 100.

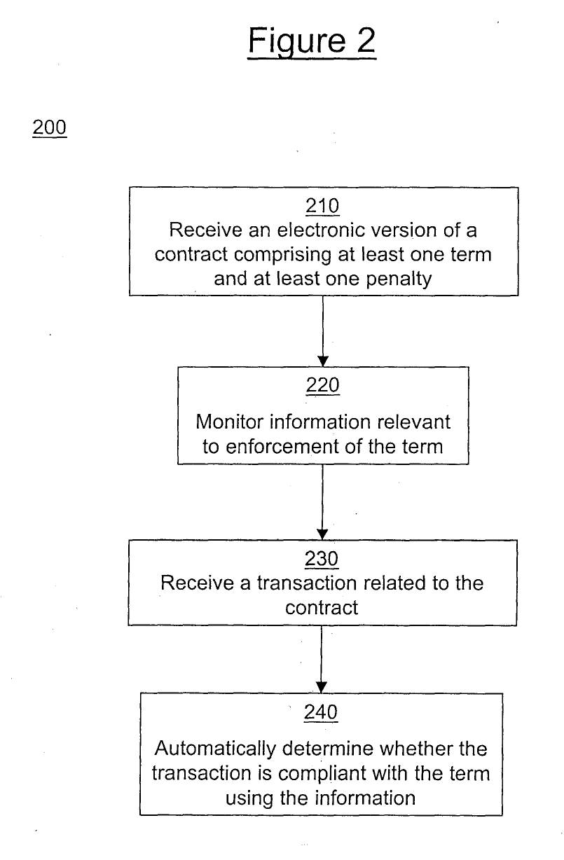

The clearing agent 120 functions as the central communications point for contract monitoring, by receiving contracts and monitoring the terms of the contracts with respect to relevant information. In one embodiment, clearing agent 120 performs a process for automatic contract monitoring (e.g., process 200 of FIG. 2). Clients 130a-n communicate with clearing agent 120 via the communications protocols of distributed computer network 110. Clearing agent 120 performs the monitoring of contracts submitted at clients 130a-n. In one embodiment, clearing agent 120 accesses information from at least one of ERP system 140, Internet 142 and public exchange 144. In another embodiment, clearing agent 120 comprises information for use in monitoring contract compliance.

A typical contract monitoring operation comprises clearing agent 120 receiving a contract from one client 130 and monitoring the compliance of terms of the contract as based on information available. In one embodiment, clearing agent 120 is configured to handle a particular type or particular types of contracts. The terms of the contract are monitored according to information available from a number of sources, including but not limited to, information stored within clearing agent 120, ERP system 140, Internet 142 and public exchange 144. It should be noted that the embodiment of the present invention depicted in FIG. 1 (e.g., system 100) is implemented as a software based process executing on the respective computer system platforms of clearing agent 120.

Referring still to FIG. 1, distributed computer network 110 may include well known network technologies. For example, distributed computer network 110 can be implemented using local area network (LAN) technologies (e.g., Ethernet, Tokenring, etc.), the Internet (e.g., Internet 142), or other wired or wireless network technologies. The communications links between clearing agent 120, clients 130a-n, ERP system 140, Internet 142, and public exchange 144 can be implemented using, for example, a telephone circuit, communications cable, optical cable, wireless link, or the like.

FIG. 2 is a flowchart illustrating steps in computer-implemented process 200 for automatic contract monitoring in accordance with one embodiment of the present invention. In one embodiment, process 200 is carried out by processors and electrical components under the control of computer readable and computer executable instructions. Although specific steps are disclosed in process 200, such steps are exemplary. That is, the embodiments of the present invention are well suited to performing various other steps or variations of the steps recited in FIG. 2. As depicted in FIG. 2, process 200 diagrams the operating process of implementing process for automatic contract monitoring as performed by, for example, clearing agent 120 of FIG. 1.

At step 210 of process 200, an electronic version of a contract is received. In one embodiment, the contract is received from a client device (e.g., client 130 of FIG. 1). The contract describes a business relationship between two or more participants. For example, the contract may describe a purchasing agreement between two businesses. However, it should be appreciated that embodiments of the present invention may be directed toward any contract describing the obligations and penalties of multiple parties.

In one embodiment, the contract is based on a standard contract template. A user may access a standard contract template on a clearing agent (e.g., clearing agent 120 f FIG. 1) at a client device. The standard contract template is configured for generating contracts of the type that are handled by the clearing agent. The template may comprise any format for entering values pertaining to relevant terms. For example, if the clearing agent is designed for handling contract related to the sale of computer memory, the contract template will allow a user to enter terms indicating item specifications (e.g., size, manufacturer, density). Furthermore, the contract template will also allow a user to enter various terms of the contract that the clearing agent is configured to handle.

In one embodiment, the contract comprises at least one term and at least one penalty. A term describes an obligation between the parties identified in the contract. For example, a term may specify that party A promises to buy twenty percent of their requirements for a specified item, and party B promises to make this amount available. A penalty describes a consequence a party is subject to in response to a breach of the term. The determination of whether or not a breach occurred, and the level of remedies in cases where it did occur, has to be based on an agreed upon a formula that processes mutually verifiable information. Traditional information sets (e.g., ERP system 140, Internet 142, and public exchange 144) can be augmented with the information held by the clearing agent so that both the discovery and damage determination decisions can be made with more information.

Embodiments of the present invention are directed towards monitoring a contract comprising incomplete terms. In other words, a term of the contract may be based on a formula using mutually verifiable information that is not available at the time the contract is created. In one embodiment, a term describes how to determine a unit price. For example, the unit price may be based on a value of the specified item according to a particular market index, or a percentage thereof. In another embodiment, the term describes how to determine an item quantity. For example, the item quantity may be based on item demand.

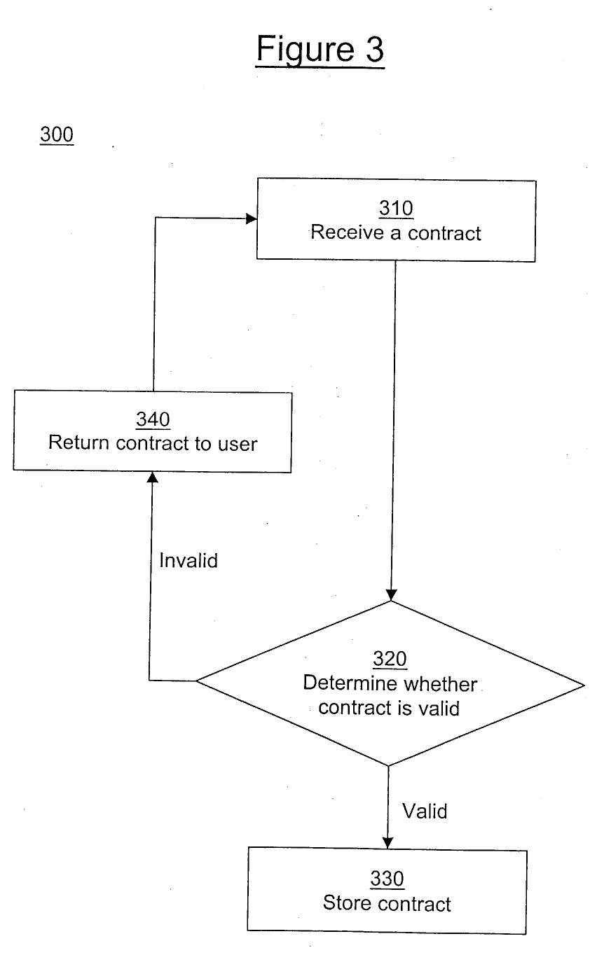

It should be appreciated that in order to automatically detect a breach of terms of the contract, the terms and penalties must be specified in a manner that can be easily and distinctly understood by the clearing agent. Accordingly, the contract must be validated upon receipt. FIG. 3 is a flowchart illustrating steps in computer-implemented process 300 for validating a contract, in accordance with one embodiment of the present invention. In one embodiment, process 300 is carried out by processors and electrical components under the control of computer readable and computer executable instructions. Although specific steps are disclosed in process 300, such steps are exemplary. That is, the embodiments of the present invention are well suited to performing various other steps or variations of the steps recited in FIG. 3. As depicted in FIG. 3, process 300 diagrams the operating process of implementing a process for validating a contract as performed by, for example, clearing agent 120 of FIG. 1.

At step 310 of process 300, a contract is received. In one embodiment, the contract received at step 310 is the contract received at step 210 of FIG. 2. At step 320, it is determined whether the contract is valid such that information provided by the terms is sufficient to determine whether a transaction is compliant with a term. For example, if a term specifies that item quantity is based on information privately held by one of the parties, the clearing agent must have access to that information in order to determine transaction compliance.

Furthermore, contract terms may be defined by events that are partially observed by the parties involved. For example, private information of the parties may be required to determine a breach of the terms and to assess a penalty. Part of this incompleteness in contracts is filled by the legal system (common law, contract law) in which the contracting parties participate. Clearing agent 120 may provide a set of general contract templates that ‘complete’ the incomplete contracts, fills in the default values based on some system level optimization of contract clauses that are left unspecified by the contracting parties based on the most recent information on current state of the system. Since this is a private legal system, these default clauses may not need to be restricted by public contract law and may reflect the implications of the specific business context (e.g., an exchange for auto parts and an exchange for electronic components may have different default values for specific contractual clauses).

For illustration purposes we will use the following scenario: A contract between parties A and B details an item specification, an item quantity, a delivery time, a delivery location and a unit price for a transaction that involves a purchase of a widget by party A from party B. The contract also specifies what would constitute a breach of this contract and the remedies in case of breach. The unit price is not completely specified. Instead, the unit price is stated in terms of information that is mutually verifiable by the two parties. An example is a contract which specifies the unit price as a function of a reference price at a specified date, say the unit price equals x % of the spot price on such-and-such date. Two common contract clauses used in specifying the per unit price are:
Most-favored-nation (MFN) clause: Per unit price is the best price B offered to other customers during a specified period of time.
Meet-the-competition-clause (MCC): Per unit price is the best price offered to A by other suppliers during a specified period of time.

In order to validate the contract, the clearing agent must have access to the spot price, the prices offered to B by other customers and the prices offered to A by other suppliers. By providing the clearing agent with access to all required information, the contract can be validated.

Provided the contract is determined to be valid, as shown in step 330, the contract is stored. In one embodiment, once the contract is stored, process 300 proceeds to step 220 of FIG. 2. Alternatively, provided the contract is not valid, the contract is not stored. In one embodiment, the contract is returned to the user, as shown at step 340, with an explanation as to why the contract was not valid. The explanation may include a suggested alternative contract. The explanation may include specific indications of what information is required for validation and how to provide that information.

With reference to FIG. 2, at step 220, information relevant to the enforcement of at least one term of the contract is monitored. For example, using the scenario as described above, the clearing agent monitors the spot price, the prices offered to B by other customers and the prices offered to A by other suppliers. This information is stored for using in verifying contract terms. In one embodiment, the monitoring of the relevant information is started once the contract is received. In another embodiment, monitoring of the relevant information is started at a time indicated in the contract (e.g., a term of the contract).

In one embodiment, the clearing agent has access to more detailed information than either party. For example, the clearing agent may have access to third party transactions involving the parties of the contract. For example, if party A, a party under the contract, buys items from a third party, the clearing agent may have access to the transaction information. However, party B, another party under the contract, will not necessarily know about this transaction. As described above, for certain contract terms, information regarding third parties is required to determine compliance of transactions.

Due to privacy issues, parties in contract typically limit access to the private business documents. For example, having a public order book may violate privacy constraints of a business. However, with currently available cryptographic technology, the clearing agent may be provided with information relevant to the decisions and actions of the parties without compromising any private information.

At step 230, a transaction related to the contract is received. In one embodiment, the transaction is between at least two parties under the contract. For example, party A purchases an amount of widgets from party B. In another embodiment, the transaction is between one party under the contract and a party not under the contract (e.g., a third party).

At step 240, whether the transaction is compliant with the term is automatically determined using the information. Having access to more detailed information than either party, the clearing agent performs the role of contract validator in accordance with the contract term. The present embodiment provides for allowing the terms of the contract as received to be specified as any function of information available to clearing agent and not restricted by information verifiable by the two parties. The contract-related communication between the two parties can be routed over the clearing agent so that the incomplete information necessary for determining the terms may be completed.

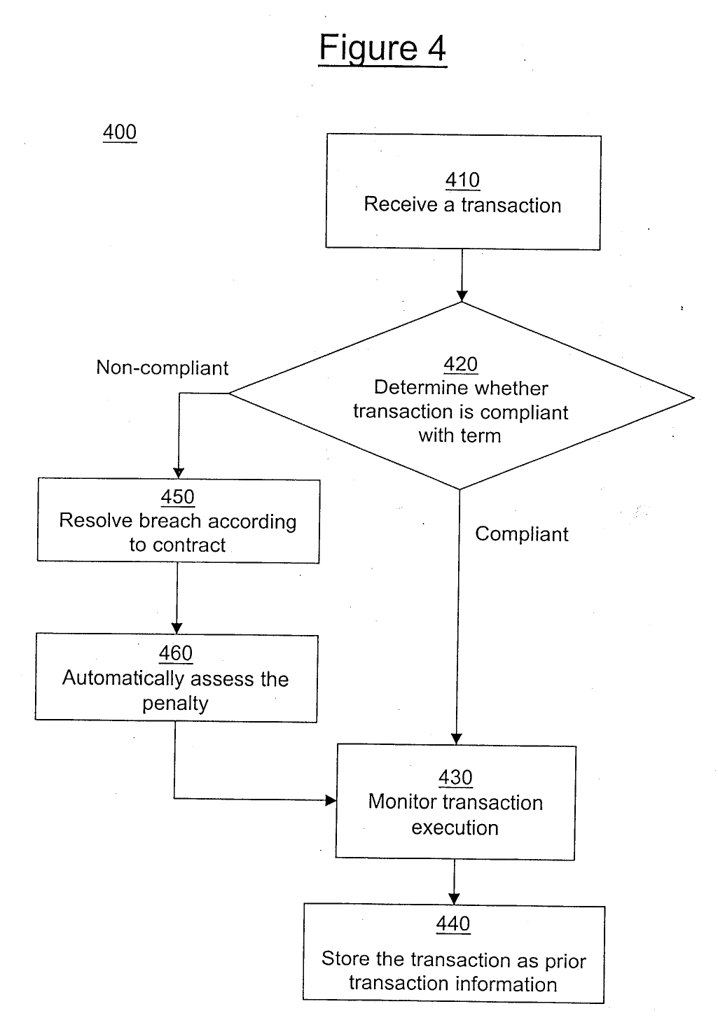

FIG. 4 is a flowchart illustrating steps in a computer-implemented process 400 for determining whether a transaction is in compliance with a contract, in accordance with one embodiment of the present invention. In one embodiment, process 400 is carried out by processors and electrical components under the control of computer readable and computer executable instructions. Although specific steps are disclosed in process 400, such steps are exemplary. That is, the embodiments of the present invention are well suited to performing various other steps or variations of the steps recited in FIG. 4. As depicted in FIG. 4, process 400 diagrams the operating process of implementing a process for determining whether a transaction is in compliance with a contract, for example, clearing agent 120 of FIG. 1.

At step 410 of process 400, a transaction is received. In one embodiment, the transaction received at step 410 is the transaction received at step 230 of FIG. 2.

At step 420, it is determined whether the transaction is compliant with terms of the contract. In order to determine whether the transaction is compliant, the clearing agent must access the information relevant to the term. For example, if a term specifies that item quantity is based on information privately held by one of the parties, the clearing agent must have access to that information in order to determine transaction compliance. If party A and party B under a contract propose a transaction, the clearing agent determines compliance of the transaction. The clearing agent checks the compliance of each term of the contract for a breach. In one embodiment, each term is completed with the relevant information.

In one embodiment, the clearing agent checks compliance of the transaction with respect to a contract between the parties of the transaction. For example, if party A and party B under a contract propose a transaction, the clearing agent determines compliance of the transaction. The clearing agent checks the compliance of each term of the contract for a breach. In one embodiment, each term is completed with the relevant information.

In another embodiment, the clearing agent checks compliance of the transaction with respect to a contract between one party of the transaction and a third party. For example, consider the situation where party A contracts to purchase at least twenty percent of its total need for an item from party B. If party A purchases the item from a third party, the transaction is checked against the contract between party A and party B for compliance. If the transaction drops the percentage of items purchased by party A from party B to less than twenty percent, the transaction breaches a term of the contract between party A and party B.

Provided the transaction is compliant with the term, as shown at step 430, the clearing agent monitors the execution of the transaction. At step 440, the clearing agent stores the transaction. In one embodiment, the transaction is stored as prior transaction information.

Provided the transaction is not compliant with the term, as shown at step 450, the breach is resolved according to the contract. For example, if a party breaches a term by failing to deliver the specified quantity, the penalty clause of the contract specifies how the non-breaching party is compensated. A common damage rule specifies that the breaching party compensate the non-breaching party for the loss due to breach. Essentially, the non-breaching party procures the item from another source and the breaching party pays for the extra costs associated with the procurement from the new source.

At step 460, the clearing agent automatically assesses the penalty to the breaching party. In one embodiment, breaches of contract are settled by the clearing agent identifying the best alternative source of the item and billing the parties according to pre-agreed rules. Process 400 then proceeds to step 430.

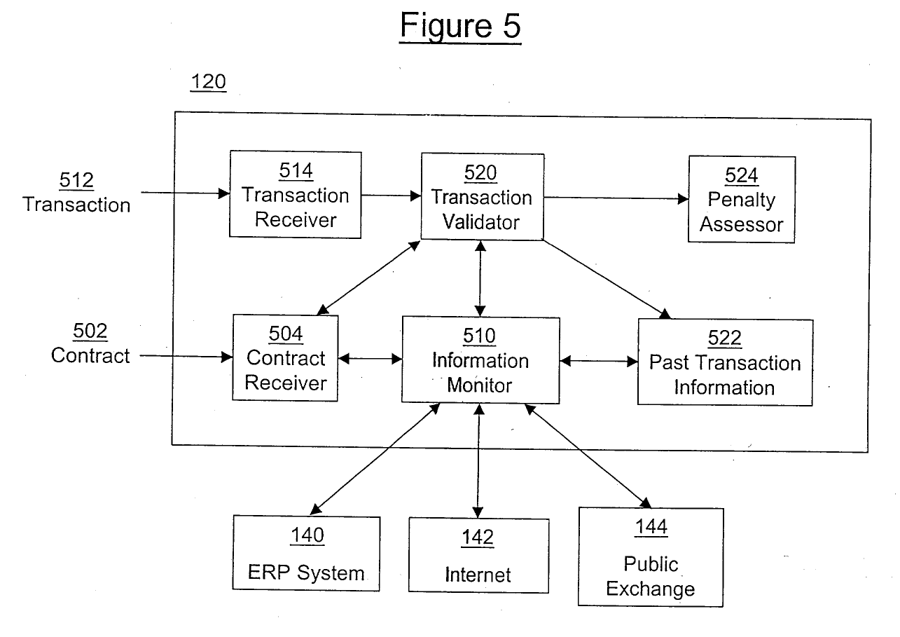

FIG. 5 illustrates a block diagram of a clearing agent 120 in accordance with an embodiment of the present invention. As depicted in FIG. 5, clearing agent 120 comprises contract receiver 504, information monitor 510, transaction receiver 514, transaction validator 520, past transaction information 522, and penalty assessor 524. In one embodiment, clearing agent 120 is a computer or computer system operable to perform a process of automatic contract monitoring, such as process 200 of FIG. 2. It should be appreciated that clearing agent 120 may be implemented as computer-readable and computer executable instructions carried out by processors and electrical components of a computer or computer system.

Contract receiver 504 is configured to receive contract 502. As described above, contract 502 is based on a contract template configured for use in clearing agent 120. Specifically, contract 502 comprises at least one term and one penalty, and is in a form that is understood by clearing agent 120. In one embodiment, contract receiver 504 stores contract 502. In another embodiment, prior to storing contract 502, contract receiver 504 determines the validity of contract 502, as described at process 300 of FIG. 3, prior to storing contract 502.

Upon receiving and storing contract 502, information monitor 510 receives instructions to begin monitoring information relevant to determine the compliance of the terms of the contract. In one embodiment, the contract comprises a clause indicating specific time for information monitor 510 to start monitoring the relevant information. Information monitor 510: monitors information from any number of sources, including but not limited to, ERP system 140, Internet 142, public exchange 144, and past transaction information 522. In one embodiment, each party of contract 502 provides access to private business information of its own ERP 140.

Transaction receiver 514 receives transaction 512. Upon receipt, transaction validator 520 determines whether the transaction is compliant with terms of contract 502. In one embodiment, transaction validator 520 performs a process of determining whether a transaction is in compliance with a contract (e.g., process 400 of FIG. 4). Transaction validator 520 accesses contract 502 as stored in contract receiver 504 to access the terms and to determine the relevant information for determining a breach. Transaction validator 520 also accesses the relevant information as stored in information monitor 510. Transaction validator 520 checks the compliance of each term of contract 502 for a breach.

Once the compliance of transaction 512 is determined, transaction 512 is stored in past transaction information 522. It should be appreciated that past transaction information 522 may comprise information related to any transaction processed by clearing agent 120, and not just those arising under contract 502. Penalty assessor 524 is operable to automatically resolve the breach and assess a penalty according to contract 502.

Embodiments of the present invention provide a method and system thereof for monitoring contract compliance. By having access to all information necessary to monitor contract compliance, contract monitoring can be automated and penalties can be automatically assessed where necessary. For instance, where long-term contracts include terms that can be verified only over time, manual contract compliance can be eliminated, providing a substantial cost and time savings. Furthermore, parties may use penalty clauses as a business tool, using them where it is beneficial to deviate from the contract and incur the penalty, and avoiding costly litigation and damage to business relationships.

Various embodiments of the present invention, a computer-implemented method for automatic contract monitoring, are thus described. While the present invention has been described in particular embodiments, it should be appreciated that the present invention should not be construed as limited by such embodiments, but rather construed according to the below claims.

1. A computer-implemented method for automatic contract monitoring, said method comprising:
receiving an electronic version of a contract comprising at least one term and at least one penalty;
monitoring information relevant to enforcement of said term;
receiving a transaction related to said contract; and
automatically determining whether said transaction is compliant with said term using said information.

2. The computer-implemented method as recited in claim 1 further comprising, provided said transaction is not compliant with said term, automatically assessing said penalty.

3. The computer-implemented method as recited in claim 1 wherein said information comprises prior transaction information.

4. The computer-implemented method as recited in claim 3 wherein said prior transaction information relates to a third party transaction.

5. The computer-implemented method as recited in claim 1 wherein said information comprises public pricing information.

6. The computer-implemented method as recited in claim 1 further comprising checking the validity of the contract such that said information is sufficient to determine whether said transaction is compliant with said term.

7. The computer-implemented method as recited in claim 1 further comprising storing said transaction as prior transaction information.

8. The computer-implemented method as recited in claim 1 wherein said contract is generated from a standardized contract template.

9. The computer-implemented method as recited in claim 1 wherein said term describes how to determine a unit price.

10. The computer-implemented method as recited in claim 1 wherein said term describes how to determine an item quantity.

11. The computer-implemented method as recited in claim 1 wherein said term identifies an item specification.

12. A computer-readable medium having computer-readable program code embodied therein for causing a computer system to perform a method for automatic contract monitoring, said method comprising:
receiving an electronic version of a contract describing a relationship between a first party and a second party, said contract comprising at least one term and at least one penalty, wherein said term describes an obligation between said first party and said second party and wherein said penalty is assessed in the event said term is breached;
aggregating information relevant to detecting a breach of said term, wherein said information comprises data necessary to detect said breach;
receiving a transaction relevant to said contract; and
automatically determining whether said transaction breaches said term of said contract using said information.

13. The computer-readable medium as recited in claim 12 further comprising, provided said transaction breaches said term, automatically assessing said penalty.

14. The computer-readable medium as recited in claim 12 wherein said information comprises prior transaction information.

15. The computer-readable medium as recited in claim 14 wherein said prior transaction information relates to a third party transaction.

16. The computer-readable medium as recited in claim 14 wherein said information comprises public pricing information.

17. The computer-readable medium as recited in claim 14 wherein said method further comprises checking the validity of the contract such that said information is sufficient to detect said breach.

18. A market-clearing system comprising:
means for receiving an electronic version of a contract comprising at least one term and at least one penalty;
means for monitoring information relevant to enforcement of said contract;
means for receiving a transaction under said contract; and
means for automatically determining whether said transaction is compliant with said contract using said information.

19. The market-clearing system as recited in claim 18 further comprising means for automatically assessing said penalty provided said transaction breaches said term.

20. The market-clearing system as recited in claim 18 wherein said information comprises prior transaction information.

21. The market-clearing system as recited in claim 20 wherein said prior transaction information relates to a third party transaction.

22. The market-clearing system as recited in claim 20 wherein said information comprises public pricing information.

23. The market-clearing system as recited in claim 18 wherein said method further comprises checking the validity of the contract such that said information is sufficient to detect said breach.
